(19) United States
(12) Patent Application Publication
(10) Pub. No.: US 2022/0099167 A1
(43) Pub. Date: Mar. 31, 2022

(54) MECHANICAL ACTUATOR

(71) Applicant: CIE Automotive, S.A., Bilbao (Bizkaia) (ES)

(72) Inventors: Ander Azkarate Retolaza, Bilbao (Bizkaia) (ES); Néstor Irisarri Ocaranza, Bilbao (Bizkaia) (ES)

(21) Appl. No.: 17/486,254

(22) Filed: Sep. 27, 2021

(30) Foreign Application Priority Data
Sep. 28, 2020 (EP) 20382853.8

(51) Int. Cl. F16H 25/22

(52) U.S. Cl. CPC F16H 25/2204

(57) ABSTRACT

A mechanical actuator for vehicles includes a ball nut having a hardened inner part defining a ball track, a malleable outer part comprising a riveting area with a riveting edge, and a bearing riveted with the riveting edge to the riveting area of the outer part of the ball nut.

### FIELD OF THE INVENTION

The present invention refers to mechanical actuators comprising ball nuts and bearings and a process of manufacturing of mechanical actuators.

### BACKGROUND OF THE INVENTION

Conventional ball nuts 100 as shown in FIG. 1 comprise fixing means in the outer part of the ball nut 100 to permit the fixation of a bearing (not shown) adapted to be fixed to an outer surface 120 of the ball nut. The fixing means normally comprise a nut for a threaded surface 110 formed on the outer part of the ball nut 100.

The use of a nut as fixing means in ball nuts is a space consuming technique that increases the manufacturing cost, time and complexity.

The present invention aims to solve at least the aforementioned limitations given by the use of nuts as fixing means in ball nuts.

### SUMMARY OF THE INVENTION

The present invention relates to a mechanical actuator for the automotive industry. The mechanical actuator comprises a ball nut that does not require the use of a nut as fixing means for fixing a bearing. Consequently, a threaded surface suitable for receiving a nut and located on the outer part of the ball nut is not required anymore and hence, the manufacturing process of the ball nut is eased and accelerated, and the material cost is reduced.

In a first aspect, the present invention relates to a mechanical actuator for vehicles. The mechanical actuator comprises a ball nut. The ball nut comprises a hardened inner part that defines a ball track for allocating a rack and recirculating balls acting as a bearing. Furthermore, the ball nut comprises a malleable outer part comprising a riveting area with a riveting edge. The mechanical actuator further comprises a bearing riveted with the riveting edge to the riveting area of the outer part of the ball nut.

In some examples, the mechanical actuator further comprises a rack and a plurality of balls for the ball track allocated in the inner part of the ball nut.

In a second aspect, the present invention relates to a manufacturing process of a mechanical actuator for vehicles, the process comprises obtaining a ball nut comprising an inner part defining a ball track and a malleable outer part comprising a riveting area with a riveting edge. The process comprises performing induction hardening of the inner part of the ball nut to obtain a hardened inner part. The process further comprises riveting a bearing with the riveting edge to the riveting area of the outer part of the ball nut to obtain the mechanical actuator.

These and other objects, advantages and features of the invention will become apparent upon review of the following specification in conjunction with the drawings.

### BRIEF DESCRIPTION OF THE DRAWINGS

For a better understanding the above explanation and for the sole purpose of providing an example, some non-limiting drawings are included that schematically depict a practical embodiment.

FIG. 1 shows a conventional ball nut;

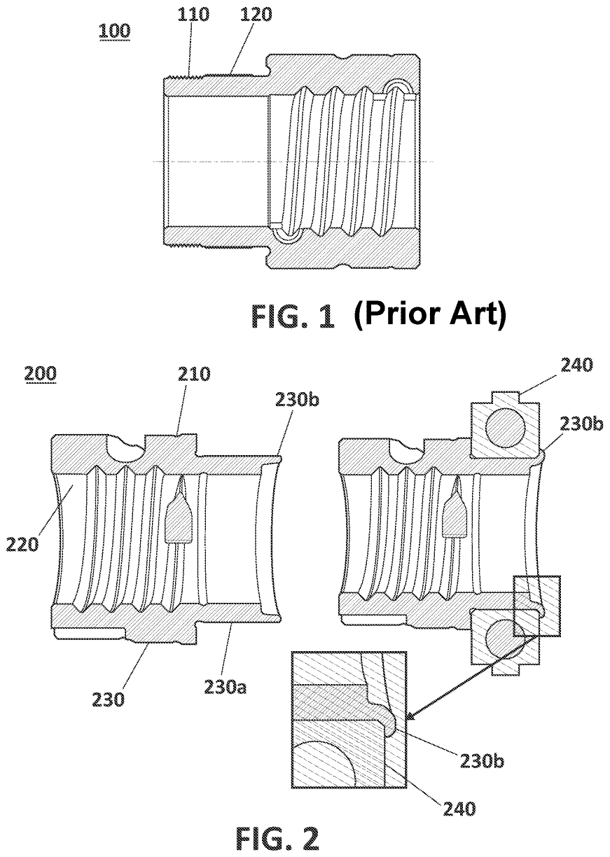

FIGS. 2 and 3 are section views of an example of a mechanical actuator according to the present invention; and

FIGS. 4 and 5 are perspective views of an example of a mechanical actuator according to the present invention.

### DESCRIPTION OF A PREFERRED EMBODIMENT

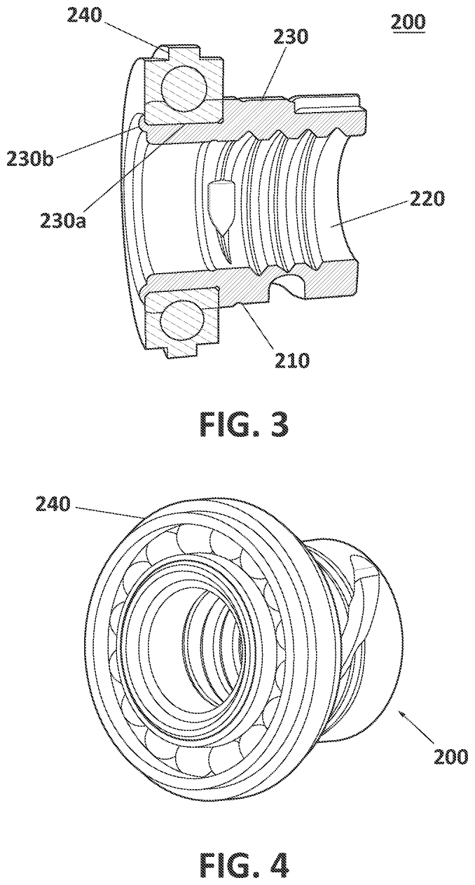

FIG. 2 shows an example of a mechanical actuator 200 for vehicles according to the present invention.

The mechanical actuator comprises a ball nut 210 which comprises a hardened inner part 220 that defines a ball track. In this example, the material of the ball nut 210 is carbon steel. Other materials can be used in further examples. The inner part 220 is hardened by performing induction hardening. Hardening is needed for the structure requirements of the inner part 200, where circulating balls are acting as a bearing for a rack adapted to be allocated in the inner part 200 of the ball nut 210. Induction hardening permits a hardening of selected parts of the ball nut 210 while keeping other parts unhardened and hence, more malleable and ductile.

Furthermore, the ball nut 210 comprises a malleable outer part 230. The malleable outer part 230 comprises a riveting area 230a with a riveting edge 230b. As mentioned, the induction hardening is only performed to the inner part 220 of the ball nut 210 so the outer part 230 having the riveting area 230a and the riveting edge 230b remains ductile, and hence; as shown in the zoom of FIG. 2, a riveting of the bearing 240 with the riveting edge 230b can be easily carried out without resulting in cracks.

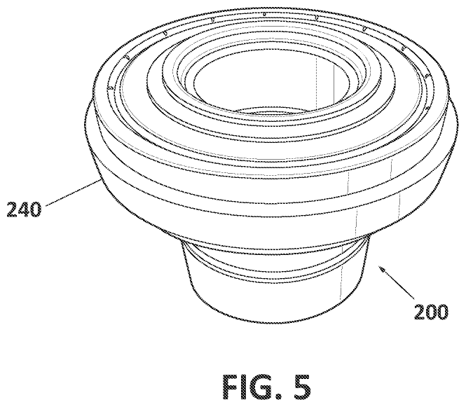

As shown in FIG. 2, the bearing 240 (having bearing balls shown in FIG. 4) is riveted with the riveting edge 230b to the riveting area 230a of the outer part 230 of the ball nut 210. As previously mentioned, for this riveting to be possible, the ball nut outer part 230 material needs not to be hardened and remain ductile. The riveting of the bearing 240 as a fixation procedure permits avoiding the use of conventional fixation means as nuts. As mentioned, the threaded surface for a nut on the outer part of the ball nut is not required anymore. Consequently, the manufacturing process is eased and accelerated and the outer part 230 surface of the ball nut 210 is decreased permitting a material cost reduction.

FIG. 3 shows another section of the mechanical actuator 200 comprising the ball nut 210 and the bearing 240 fixed to the ball nut 210 by riveting said bearing 240 with the riveting edge 230b to the riveting area 230a of the outer part of the ball nut 210. As shown in FIG. 3, the bearing 240 comprises a circular track for bearing balls that are shown in FIG. 4.

FIG. 4 shows a first view of the mechanical actuator 200 showing the bearing 240 comprising a circular track with bearing balls. FIG. 5 shows another view of the mechanical actuator 200 with the bearing 240 riveted to the ball nut 210.

Furthermore, in further examples not shown, the mechanical actuator 200 comprises, in the inner part 220, a rack and a plurality of balls for the ball track of the hardened inner part wherein induction hardening is performed.

It will be appreciated that the invention is not limited to the embodiment(s) described herein, but can be amended or modified without departing from the scope of the present invention, which his intended to be limited only by the scope of the appended claims as interpreted according to the principles of patent law including the doctrine of equivalents.

1. A mechanical actuator for vehicles, comprising:
a ball nut comprising:
a hardened inner part defining a ball track;
a malleable outer part comprising a riveting area with a riveting edge; and
a bearing riveted with the riveting edge to the riveting area of the outer part of the ball nut.

2. The mechanical actuator according to claim 1, wherein the ball nut comprises carbon steel.

3. The mechanical actuator according to claim 2, further comprising:
a rack; and
a plurality of balls for the ball track.

4. The mechanical actuator according to claim 1, further comprising:
a rack; and
a plurality of balls for the ball track.

5. A manufacturing process of a mechanical actuator for vehicles, the process comprising:
obtaining a ball nut comprising an inner part defining a ball track and a malleable outer part comprising a riveting area with a riveting edge;
performing induction hardening of the inner part to obtain a hardened inner part; and
riveting a bearing with the riveting edge to the riveting area of the outer part of the ball nut to obtain the mechanical actuator.
